(19) United States
(12) Patent Application Publication
(10) Pub. No.: US 2009/0140985 A1
(43) Pub. Date: Jun. 4, 2009

(54) COMPUTING DEVICE THAT DETERMINES AND USES APPLIED PRESSURE FROM USER INTERACTION WITH AN INPUT INTERFACE

(76) Inventor: Eric Liu, Santa Clara, CA (US)

Correspondence Address: SHEMWELL MAHAMEDI LLP, 4880 STEVENS CREEK BOULEVARD, SUITE 201, SAN JOSE, CA, 95129-1034, US

(21) Appl. No.: 11/948,885

(22) Filed: Nov. 30, 2007

(51) Int. Cl. G06F 3/02; G09G 5/00

(52) U.S. Cl. 345/168; 345/156

(57) ABSTRACT

A computing device processes input by determining one or more inputs corresponding to a user interacting with an input interface. In an embodiment, the input interface may correspond to a button state or to a multi-state input interface. A value corresponding to an amount of pressure applied by the user is determined on the computing device. The value is determined during an instance or duration in which the user is interacting with the input interface. The value for the applied pressure is determined apart from the input. In one embodiment, the value is determined using a force sensor that is separate from the input interface. An operation is then performed that is responsive to the determined amount of pressure, as well as to the one or more inputs.

### TECHNICAL FIELD

Embodiments described herein pertain to computing devices, and more particularly, to interface mechanisms of computing devices.

### BACKGROUND

Computing devices, particularly handheld and portable devices, have evolved to include numerous types of communication capabilities and functionality. For example, handheld devices exist that operate as cellular phones, messaging terminals, Internet devices, while including personal information management (PIM) software and photo-management applications. Additionally, Internet Protocol services exist that can transform Internet-enabled machines into telephony devices. Even stand-alone telephones that connect to traditional Public Switched Telephone Networks (PSTN) are including more software to enhance the telephone's functionality.

In enhancing communication capabilities and functionality, effort has been made to enhance and assist the user in using such devices. For example, software features exist to facilitate the ease in which the user can act on a phone number in an email message. A sequence of phone numbers can be presented to a user for selection, and upon such selection being made, a telephony application uses the phone number in making a phone call. Small form-factor computing devices, such as devices that provide cellular phone functionality, have particular use for such short-cut functionality, in order to reduce the manual involvement of the user. These devices have smaller keyboards that may be harder to operate, and/or use in mobile or dynamic environments, where the user cannot readily retrieve a desired number.

Telephony devices are just one type of communication device. There are now many types of communication types, and multi-functional devices exist to accommodate the different communication types. Examples of communication types other than telephony include email, instant message (including SMS protocol messages and Multimedia Message Service (MMS) protocol messages), and video conferencing. Many computing devices, particularly smart phones, are enabled to support communications using multiple communication mediums.

### BRIEF DESCRIPTION OF THE DRAWINGS

FIG. 1 is a simplified and exploded side-view of a computing device configured in accordance with an embodiment of the invention.

FIG. 2A is a top view illustrating an interface assembly for use with a computing device such as shown in FIG. 1, according to an embodiment of the invention.

FIG. 2B is a side view of the interface assembly of FIG. 2A, under an embodiment of the invention.

FIG. 3 is a hardware block diagram of a computing device, according to an embodiment of the invention.

FIG. 4 is a method for using applied pressure to affect operations of a computing device, according to an embodiment of the invention.

### DETAILED DESCRIPTION

Embodiments described herein provide for a computing device that is configured to determine and use applied pressure from the user in determining how to respond to user input. According to an embodiment, a processor of computing device responds to the user operating an input interface mechanism with ‘heavy’ pressure by altering or otherwise adjusting the input that the user is entering. In the case where the user's input is repetitive or directional, the processor may magnify or enhance the input of the user in relation to the amount of pressure detected. Numerous other examples are provided herein.

According to an embodiment, a computing device processes input by determining one or more inputs corresponding to a user interacting with an input interface. In an embodiment, the input interface may correspond to a button state or to a multi-state input interface. A value corresponding to an amount of pressure applied by the user is determined on the computing device. The value is determined during an instance or duration in which the user is interacting with the input interface. The value for the applied pressure is determined apart from the input. In one embodiment, the value is determined using a force sensor that is separate from the input interface. An operation is then performed that is responsive to the determined amount of pressure, as well as to the one or more inputs.

According to another embodiment, a computing device includes a processor, a multi-state interface, and a pressure-sensitive mechanism. The multi-state interface component is coupled to the processor and configured to be operable to actuate an input to the processor for any one of a plurality of actuated states. The pressure-sensitive mechanism is positioned to detect pressure applied by the user when operating the multi-state interface. The pressure-sensitive mechanism may be coupled to provide an output for use by the processor, where the output corresponds to a value of the pressure applied by the user. In an embodiment, the processor is configured to detect whether the value of the pressure applied by the user when operating the multi-state interface exceeds a designated threshold. In response to detecting that the pressure applied by the user when operating the multi-state interface exceeds the designated threshold, the processor is configured to alter performance of one or more operations based on the combination of the value of the pressure and the input from the multi-state interface. In response to detecting that the pressure applied by the user when operating the multi-state interface does not exceed the designated threshold, the processor is also configured perform one or more operations based on the input from the multi-state interface and not the value of the applied pressure.

In another embodiment, a computing device is configured to process input by detecting that pressure applied by a user when interacting with an input interface on the computing device exceeds a threshold. In response to detecting that the pressure exceeds the threshold, the computing device performs an operation that is based on combining one or more inputs from the input interface and a value that corresponds to an amount of pressure applied by the user.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

Additionally, one or more embodiments described herein may be implemented using modules. A module may include a program, a subroutine, a portion of a program, or a software component or a hardware component capable of performing one or more stated tasks or functions. As used herein, a module can exist on a hardware component independently of other modules, or a module can be a shared element or process of other modules, programs or machines.

Furthermore, one or more embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums.

A multi-state interface refers to a mechanism, or combination of mechanisms that combine to form an interface that has multiple actuated states.

Device Overview

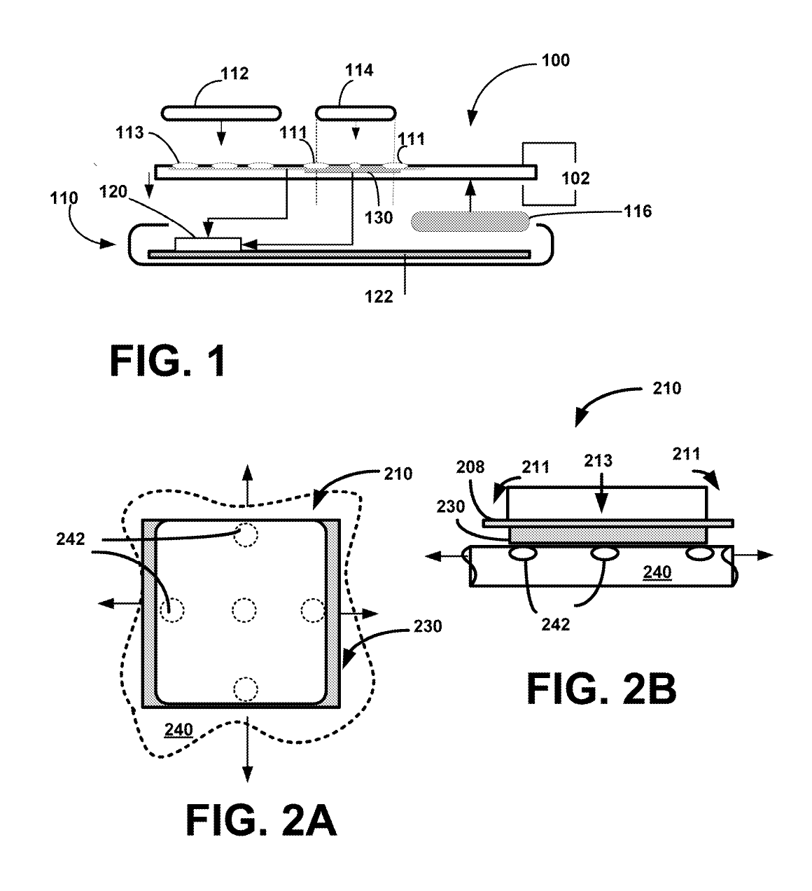

In FIG. 1, a computing device 100 includes a housing 110 on which a plurality of interface or input mechanisms are provided on an interface layer 102. The housing 110 retains various hardware components, including a processor 120 or processing resources (e.g. multiple processors) and different forms of memory resources. Other components, such as an analog/digital converter (not shown), data busses and battery source (not shown) may also be retained within the housing 110. A printed circuit board 122 or other substrate or interconnect mechanism may electrically connect the various elements. For purpose of an embodiment such as shown and described, the computing device 100 corresponds to a cellular telephony/messaging device (such as so-called ‘smart phones’), although the device 100 may correspond to any one of many kinds of computing devices, including media payers, Global Positioning System devices, image or video capturing devices, and multi-function devices.

The interface layer 102 may form an exterior surface of the housing 110. The interface layer 102 may be in the form of substrate that includes a variety of different types of interfaces for enabling the user to enter input and interact with the device. In one implementation, the substrate composition of the interface layer 102 may include a printed circuit board including electrical interconnect elements that couple the individual interfaces to the processor 120 and/or other elements retained within the housing (e.g. analog-digital converter). As an alternative to the printed circuit board, the substrate of the layer 102 may alternatively be semi-rigid layer or membrane that provides support for individual interface mechanisms. For example, the keypad 112 may be a self-contained module that interconnects with other components in the housing via a flex cable. Still further, the interface layer 102 may include separated substrates, or alternatively, some of the input interfaces may be provided without use of a substrate. As such, the interface layer 102 may refer to an occupied thickness that includes any one or more interfaces for entering input and providing output.

In an embodiment, the interfaces of the layer 102 include a keypad 112, a multi-state interface 114, and a display assembly 116. The display assembly 116 may optionally be contact-sensitive, or otherwise operable to detect physical interaction from the user. For example, the display assembly 116 may be capacitive, to detect touch. Alternatively, the display assembly may include resistive sensors that detect force. Still further, the display assembly may include optical sensors so as to be sensitive to light. In the latter case, the user may contact the display, and the display assembly may detect the interaction through changes in light cast onto the sensors. In either case, the sensors of a contact-sensitive display assembly operate independent of the pressure-sensitive mechanism 130.

The multi-state interface 114 may include one or more buttons or actuation mechanisms that combine to provide mult. An example of a multi-way interface is a 5-way button pad or set, which may include (under one implementation) a navigation pad that can be moved or toggled to actuate in four directions, and a central button that can be pressed or otherwise actuated to cause selection input via central actuation. The interface layer 102 may provide or enable electrical interconnectivity between any of the input interfaces and hardware components that are contained within the computing device. Numerous types of interface mechanisms may be used in connection with one or more embodiments described, including buttons or keys, switches, pads or other actuatable mechanisms and combinations thereof.

Some or all of the interfaces provided on layer 102 may be switched, or otherwise digital in nature. In one embodiment, the multi-state interface 114 may be provided as toggled or independent buttons that, when pressed, actuate a corresponding switch element 111. The switch element 111 signals actuation of the multi-state interface 114 into a particular actuated set. In the case where the multi-state interface is a 5-way (or, for example, 8-way) interface, a switch may be provided for each directional state of the interface, and a center switch may provide for a central (i.e. selection) state of the interface.

In addition to the various input interfaces of the layer 102, embodiments described herein provide that the computing device 100 includes a pressure-sensitive mechanism 130 that detects an amount or magnitude of pressure applied to one or more of the interfaces of the interface layer 102. According to an embodiment, the pressure-sensitive mechanism 130 is positioned to detect pressure applied to the multi-state interface 114. In an embodiment of FIG. 1, the pressure-sensitive mechanism 130 may underlie the multi-state interface 114 so as to detect force applied by the user when operating any one or more of the buttons of the multi-state interface 114. A deformable layer made of, for example, rubber or silicon rubber may separate the mechanism 130 from the multi-state interface. As an alternative, the pressure sensitive mechanism may be provided adjacent to the multi-state interface 114.

According to an embodiment of FIG. 1, the pressure-sensitive mechanism 130 is on the substrate of the interface layer 102. The pressure-sensitive mechanism 130 may be provided as a separate component from the substrate. As an alternative, the pressure sensitive mechanism 130 may be integrated with or into the substrate of the interface layer 102. Numerous other variations to the positioning of the pressure-sensitive mechanism are contemplated.

The pressure-sensitive mechanism 130 may be provided as a force transducer or other force sensor. Under another embodiment, the pressure-sensitive mechanisms 130 may correspond to a strain gauge. The output of the pressure-sensitive mechanism may be provided an analog value. An analog-digital converter or resource may be used to convert the output from the force sensor to a digital form.

As will be described, one or more embodiments provide that processor 120 may receive and use input from both the multi-state interface 114 and the pressure-sensitive mechanism 130. For example, in the case where the applied pressure from the user is detected by the mechanism 130 as exceeding a threshold, the processor 120 may utilize both the analog value representing the applied pressure and the input being entered by the user selecting one of the states of the multi-state interface 114. Thus, the device is configured to receive data that originates from both a digital source (multi-state interface 114, via switch elements 111) and an analog source (pressure-sensitive mechanism 130). An analog-digital converter or resource may be used to convert the analog form of the output of the pressure-sensitive mechanism into a digital form for use by the processor 120.

An embodiment recognizes that a user may apply force as an inherent or natural reaction to indicate a desired magnitude or value of the input that the user is attempting to enter. For example, when the user is entering navigation input, the user may press harder as a natural inclination to make the navigation in a particular direction move faster. In an embodiment, the pressure-sensitive mechanism 130 is positioned relative to a specific interface or set of interfaces on the interface layer 102 to determine when (i) the user applies a pressure that exceeds a designated threshold when interacting with the specific interface, and (ii) determine a value of the applied pressure (particularly when the pressure exceeds the threshold). In an embodiment, when the pressure exceeds a specific threshold while the user is interacting with the specific interface (i.e. multi-state interface 114), the value of the applied pressure is used to affect the operation of the processor 120. In one implementation, if the applied pressure detected from the user interacting with the multi-state interface 114 exceeds a designated threshold while the user is interacting with the multi-state interface 114, the processor 120 will combine the values received from both the pressure-sensitive mechanism 130 and the multi-state interface 114 to determine an input that accounts for both the applied pressure and the button selected.

If during the period of interaction, the pressure-sensitive mechanism 130 does not detect an applied pressure that exceeds the threshold, an embodiment provides that the analog value (if any) of the pressure-sensitive mechanism 130 is not used by the processor 120 (at least in connection with processing input from the input interface). Rather, the processor 120 only utilizes the input from the multi-state interface 114. For example, in the case where the multi-state interface 114 corresponds to a multi-way interface mechanism, the processor 120 may use only the input from the user's interaction with the multi-way interface mechanism when the applied pressure is not detected by the pressure-sensitive mechanism 130 as exceeding the threshold.

Still further, an embodiment provides that if during the period of interaction, the pressure-sensitive mechanism 130 does detect (i) the applied pressure exceeding the threshold, (ii) then falling below the threshold while the interaction is ongoing, the processor may still utilize the analog value for the applied pressure. For example, the reduction in applied pressure may be interpreted to reduce velocity or acceleration of the applied pressure.

Under one embodiment, the user may operate the multi-state interface 114 to enter directional input. The value of the applied pressure, as determined from the pressure-sensitive mechanism 130, determines the velocity and/or acceleration by which the directional input is used. For example, in the case where the directional input corresponds to scrolling or navigation, the value of the applied pressure increases a velocity at which the scrolling or navigation takes place.

Additionally, embodiments recognize that the user may inherently adjust the applied pressure based on viewing or receiving feedback regarding the effects of the input being entered. In such cases, the user may inherently reduce the applied pressure. For example, in the case when the user is scrolling, the value of the applied pressure, as determined from the pressure-sensitive mechanism 130, may be used to determine the speed that the scroll action is performed. The user may apply heavy pressure when scrolling through numerous entries when the user has knowledge that he is far from the desired entry. In an embodiment, the heavy pressure applied by the user causes otherwise fast scrolling to be magnified, in proportion or otherwise based on the value of the applied pressure in combination with the repeated directional input (which may be digital). But as the user nears the desired entry, the user may relax the pressure, which reduces the detected value of the applied pressure, and thus slows the speed at which scrolling is performed.

Interface Assembly

FIG. 2A is a top view illustrating an interface assembly for use with a computing device such as shown in FIG. 1, according to an embodiment of the invention. FIG. 2B illustrates a side-view of the interface assembly shown in FIG. 2A. In an embodiment of FIG. 2A, a 5-way interface component 210 is positioned over a pressure-sensitive mechanism 230. As shown by FIG. 2B, an embodiment positions the 5-way interface component 210 to overlie the pressure-sensitive mechanism 230. Both the interface component 210 and the pressure-sensitive mechanism 230 reside on a printed circuit board 240. A spacer or tactile layer may be provided between the pressure-sensitive mechanism 230 and the interface component 210, and/or between the pressure-sensitive mechanism 230 and the substrate 240.

A user may operate the 5-way interface component 210 to actuate the component into one of five possible states: four directional states corresponding to directions (north, south, east, west) and one central state corresponding to selection or other non-directional input. In one implementation, each state of the 5-way interface component 210 may be pressed or pushed by the user to actuate an underlying switch 242, which may be provided on the printed circuit board 240. The 5-way interface component 210 may correspond to one or more structures that overlay the switches 242. For example, the interface component 210 may correspond to a disc that is insertable over each switch 242 to actuate one of five possible actuated states. In another variation, the interface component 210 includes an outer ring and center button, with the outer ring being insertable over each switch 242, and the center button being insertable over the center switch 242. Still further, other variations for the structure of the 5-way interface component 210 may be used, such as separate button structures for each state.

According to an embodiment, each actuated state of the interface component 210 is triggered by actuation of a corresponding underlying switch 242. In one implementation, the switch 242 corresponds to snap-dome, which requires some physical force to close or actuate. For example, pressure applied to a disk of the interface component 210 for the south direction may result in actuation of the underlying switch 242 for that section of the disk. A press and hold in over the switch 242 of the south direction may generate repeated digital type signals indicating actuation of the switch 242 for that direction. For example, there may be several actuations per second. A press and hold may result n a maximum number of actuations.

As an alternative to switch or digital buttons, capacitive or resistive buttons may also be used. In particular, capacitive and resistive buttons may be configured to operate as digital-type buttons and substituted for one of the switched devices described in the preceding paragraph.

Independent of the individual switch elements 242 and the insertion force needed to actuate those switches, the pressure-sensitive mechanism 230 measures the applied force from the user when pressing the disk or other structure element of the 5-way component 210 inward. As mentioned with an embodiment of FIG. 1, if the user applies pressure that is sufficient to exceed the threshold, the pressure-sensitive mechanism provides an analog value that can used by the processing resources of the computing device to determine the amount of pressure that is being applied to the interface component 210. If the applied pressure does not exceed the threshold, an embodiment provides that only the interface component 210 output is used by the processor.

Thus, for example, a press and hold of the 5-way interface component 210 over a particular switch 242 may result in numerous input entries being entered for the processor 120 (see FIG. 1). However, if the applied pressure is measured (i.e. the pressure exceeds the threshold), an embodiment provides that the analog value magnifies or otherwise enhances the cumulative input that would otherwise be generated from the press and hold. For example, in the absence of use of the applied pressure value, the press and hold may simply cause the processor to perform the same action of scrolling from entry to entry, or through entries, at a common pace (e.g. the maximum pace, for press and hold). With the presence of the applied pressure value, however, the processing from the device may be altered or configured to be enhanced. For example, the speed at which the operation (e.g. scrolling) is performed may increase, in proportion to the value of the pressure-sensitive component 230.

As another example, the user may make a single forceful press, which may enhance that input or cause the processor to account for the detected pressure through some form or configuration. For example, in any of the scenarios described, the analog value of the applied pressure may alter or configure an operation that would otherwise be performed by the processor of the device.

Hardware Overview

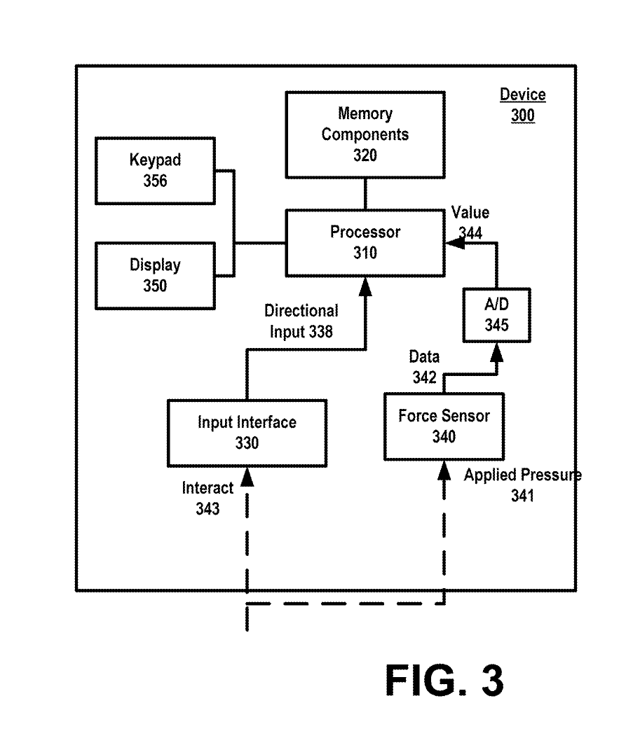

FIG. 3 is a hardware block diagram of a computing device, according to an embodiment of the invention. In an embodiment, a device 300 includes a processor 310 (or processing resource), memory components 320, various input interface components 330, one or more data busses (not shown) provided between the interface components 330 and the processor 310, and a force sensor 340. The force sensor 340 may correspond to an analog component, and as such, may be coupled to the processor 310 via an analog/digital converter 345. Other components of the device 300 may include a display assembly 350 (which may be contact or touch sensitive) and one or more additional input interfaces 356 (e.g. keypad or keyboard). An embodiment of FIG. 3 may be used to implement, for example, any of the embodiments described with FIG. 1 or FIG. 2.

In an embodiment, the force sensor 340 is coupled to detect and measure applied pressure for when the user operates or otherwise interacts with one of the input interface components 330. As an alternative or addition, the force sensor 340 may operate with more than one input interface component 330. For example, some devices use a 5-way interface component such as described with an embodiment of FIG. 2 in connection with a panel of buttons or actuation mechanisms that perform dedicated (or semi-dedicated) functions, such as call-answer, call hang-up, application launch, or menu launch. As an alternative or addition, (i) the entire panel may be coupled to the use of the force sensor 340; (ii) the force sensor 340 may be used with the keypad 356 or keyboard (e.g. such as one that enables keys to have directional values), or (iii) the force sensor 340 may be used with the display 350 (e.g. capacitive touch-sensitive display). Under an embodiment, a device includes a single force sensor 340, although multiple force sensors 340 may be used. In any of the implementations, data 342 may be generated by the force sensor 340 to correspond to a measure of pressure 341 applied to the interface component 330 when the user is interacting 343 with a particular input mechanism. In one implementation, the data 342 generated from the force sensor 340 is converted into a value 344 that is indicative or proportional to the measurement of the applied force from the user.

In one embodiment, processor 310 selectively uses data 342 generated from the force sensor 340 in combination with input entered by the user through the particular input interface component 330 that the force sensor is coupled to. For example, certain conditions relating to the state of the device and/or the manner in which the user is operating the device must be met before data from the force sensor 340 is used by the processor 310. These conditions may serve to check whether, for example, the force sensor 340 is not providing a false reading (such as when the user places the device in his pocket) or that the measurement of force provides an accurate read of the user's intent. In an embodiment, the data generated form the force sensor 340 is used when (i) the applied pressure from the user, as measured by the force sensor 340, is greater than a threshold value, and (ii) the user is interacting with the particular input interface component 330 that is coupled to the force sensor. In one embodiment, the interaction by the user with that input interface component 330 is of a particular intensity level. For example, the condition by which data from the force sensor 340 may be used may correspond to (i) the user pressing and holding the input interface component 330 into a particular state (e.g. a directional state), (ii) the user rapidly actuating the input interface component 330 to enter numerous inputs, and/or (iii) the user simultaneously using the input interface component 330 with force that exceeds a threshold. As an addition or alternative, more than one threshold for determining when to interpret the application of force from the force sensor 340 may be implemented. For example, the threshold for determining to use the data generated from the force sensor 340 when the user is performing a press and hold on the associated input component 330 may be different than the threshold for interpreting the user forcefully interacting with the same input interface component in a more limited manner (e.g. the user presses one time).

In an embodiment, the processor 310 uses the data generated from the input interface component 330 to alter or configure an operation that is reacting or otherwise using input from the associated input interface component. When conditions for using data generated from the force sensor 340 exist, the processor 310 uses the combination of data from the force sensor 340 (analog source) and the input interface component 330 (digital source) to perform some operation. In one embodiment, the data generated from force sensor 340 is used to magnify, amplify, enhance, sensitize or otherwise adjust directional input 338. The directional input 338 may be provided by the user actuating the associated input interface component 330 into a particular actuated state corresponding to one of multiple possible directions. The directional input is then magnified or amplified in proportion to the value of the applied pressure, as indicated by the data 342 generated from the force sensor 340. As an example, directional input entered by the user when scrolling amongst data entries may be amplified in speed, and provided acceleration, in proportion or relation to the value of the applied force when the user enters the direction input. In addition to such fast scrolling, other kinds of directional input may also be affected. For example, the user may apply force to (i) fast-forward or rewind through an audio and/or video playback of a media file, or (ii) control the setting of a hardware device (e.g. dim, brighten display assembly, adjust speaker volume).

Methodology

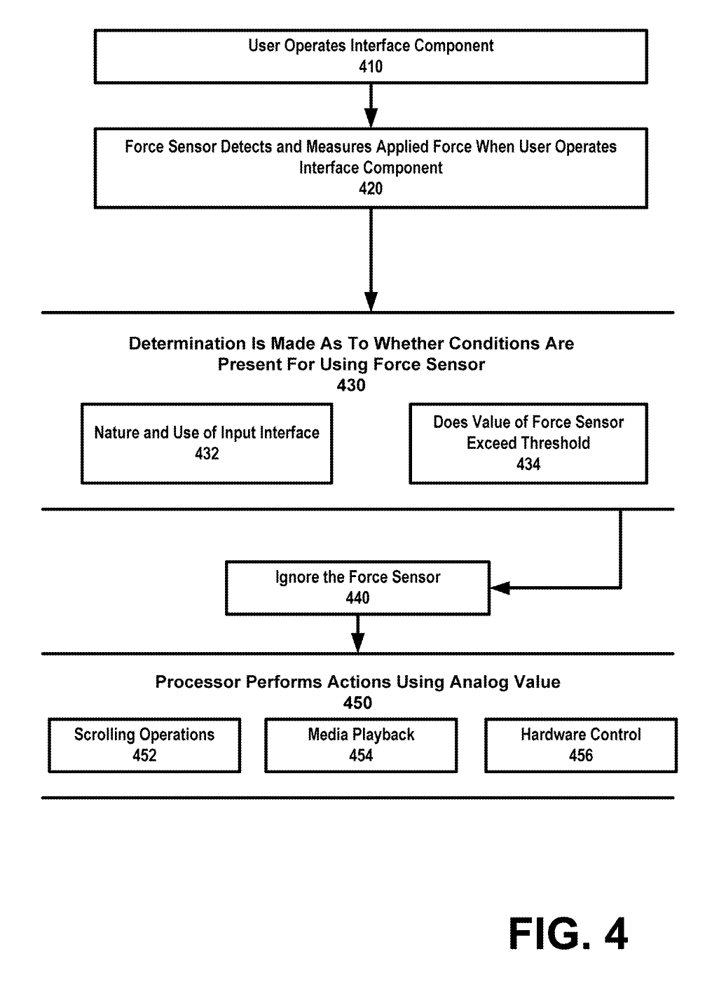

FIG. 4 is a method for using applied pressure to affect operations of a computing device, according to an embodiment of the invention. An embodiment such as described with FIG. 4 may be implemented using any of the elements or components shown with previous embodiments, including with device 300 shown by FIG. 3. Accordingly, reference may be made to elements of FIG. 3 and other elements in order to illustrate suitable elements or components for performing a step or sub-step being described.

In step 410, a user interacts with the device 300 by operating the input interface component 330. The input interface component 330 may correspond to, for example, a multi-state input mechanism such as a multi-way button set.

Step 420 provides that the force sensor 340 detects and measures the amount of pressure applied by the user to a region where the input interface component 330 is provided. For example, in the case where the input interface component 330 corresponds to a multi-way button set, the force sensor 340 may make measurement of the applied pressure from underneath or about that button set. This may measure, for example, the amount of pressure applied by the user's thumb when operating the multi-way component. The pressure measured from the force sensor 340 may be converted into an analog value 344 for use by the processor 310 of the device 300.

In step 430, the device 300 makes a determination as to whether conditions are present for using the analog value 344 generated from the force sensor 340. In an embodiment, multiple conditions may be required before the analog value 344 is used. In sub-step 432, the conditions may include a determination regarding the nature or manner of use of the input interface component 330. More specifically, an embodiment provides for a level or intensity of interaction between the user and the input interface component 330 for which applied pressure is being measured. For example, the processor 310 may require a press and hold to force repeated inputs corresponding to one of the actuated states of the input interface component 330. The press and hold may also need to satisfy a duration condition (e.g. must last one second). As an alternative condition, processor 310 may use the analog value 344 when the user enters several inputs using the input interface component 330 in a given duration of time. As still another alternative, the simultaneous use of the input interface component 330 in connection with a measured force that exceeds some threshold may satisfy a condition.

As an additional or independent condition, one or more embodiments determine in sub-step 434 as to whether the value 344 provided from the force sensor 340 exceeds some threshold value. For example, a user's interaction with the input interface component 330 that is light in force, or deemed in a normal range, may fail to satisfy the force threshold. In one embodiment, the threshold may be based on the normal pressure the user normally applies when using the input interface component 330. When the applied pressure exceeds the user's normal range by some factor, the condition of the sub-step 434 may be met.

If the determination of the device in step 430 is that the conditions are not present, then step 440 provides that the analog value 344 from the force sensor 340 is ignored. Thus, for example, the input from the input interface component 330 may be used without modification.

If however, the determination of the device in step 430 is that the conditions are present, then step 450 provides that the processor 310 modifies, alters or performs additional or substitute operations that use the analog value 344 from the force sensor 340. In one embodiment, the processor 310 combines the analog value 344 with the input 338 from the input interface component 330 in performing an operation. The analog value 344 may serve to increase velocity and/or accelerate the rate at which an existing series of actions (e.g. scrolling) take place. In one embodiment, the increase in velocity or acceleration is made proportional or otherwise dependent on the amount of pressure that is applied to the input interface component 330.

Sub-steps 452-456 provide examples of actions that the processor 310 takes to account for the analog value 344, according to one or more embodiments of the invention. Sub-step 452 applies to scrolling actions. In sub-step 452, the processor 310 may increase the speed at which the user scrolls entries, based on the amount of applied pressure that is detected (e.g. the analog value 344). Sub-step 454 applies to media playback applications. In sub-step 454, fast-forward and reverse actions are enhanced or accelerated based on the value of the analog input 344. Sub-step 456 applies to hardware control. The analog value may quicken or accelerate the rate at which a hardware component (e.g. backlight, audio level) is adjusted with repetitive input.

Different embodiments and implementations may handle differently the situation of when the applied pressure fluctuates above and below the threshold. In one embodiment, the threshold is an initial threshold, and once the applied pressure surpasses the threshold, the value 344 as determined from the applied pressure is used continuously through the user's interaction with the corresponding input interface mechanism, at least until the user's use has interrupted. Thus, the applied pressure may be used to accelerate or de-accelerate applied pressure when actions such as scrolling are performed. In such cases, the user's ‘lightening’ of the applied pressure may result in the de-acceleration of the scrolling action.

Alternatives

While embodiments described above recite numerous examples in which directional or repetitive input is enhanced or magnified with detection of applied pressure, embodiments described herein provide for numerous alternative uses for the force sensor 340, and for the use of the force sensor in combination with a given input interface components. Under one embodiment, the user may forcefully push a given button to invoke an alternative function assigned to that button. For example, the user may forcefully push a given button to turn the device off, or to turn a hardware component such as a radio-transmitter off. If the button-push is not sufficiently forceful, the use of the button may invoke some other function, such as an application launch. Such an embodiment may be implemented using, for example, any of the embodiments described with FIG. 1-FIG. 3.

As yet another example, the user may operate a keyboard or keypad and invoke alternative key values with forceful pushing or interactions. For example, the user may invoke capitalization or alternative characters by pushing a button on a keyboard with sufficient force. Alternatively, some keys on a keyboard have alternative number/letter assignments, where the number assignments allow individuals to dial phone numbers. The forceful pushing or interaction of, for example, an initial button that is intended to be a phone number may trigger a numeric mode that enables the user to enter a phone number by pressing other dual assigned keys. Such an embodiment may be implemented using, for example, any of the embodiments described with FIG. 1-FIG. 3.

As another alternative, while embodiments described above describe the use of a condition in which the applied pressure must surpass a designated threshold before the applied pressure readings are used, other embodiments may enable use of the analog value 344 in response to alternative conditions. For example, the user may manually elect to have the pressure readings used anytime interaction with the input interface component occurs. Still further, another example may enable use of a force sensor when the device is in a particular mode setting.

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. A method for processing input on a computing device, the method comprising:
determining one or more inputs corresponding to a user interacting with an input interface on the computing device;
determining a value corresponding to an amount of pressure applied by the user when the user is interacting with the input interface, wherein the value is determined apart from the input;
performing an operation that is responsive to the value corresponding to the amount of pressure and to the one or more inputs.

2. The method of claim 1, wherein performing the operation is performed in response determining that the value exceeds a threshold.

3. The method of claim 1, wherein determining one or more inputs corresponds to detecting operation of a device that is operable to actuate one or more switches.

4. The method of claim 1, wherein determining one or more inputs corresponds to detecting operation of a device that is operable to actuate a digital input.

5. The method of claim 3, wherein determining a value corresponding to an amount of pressure applied by the user includes determining a value from an analog sensor.

6. The method of claim 1, wherein performing the operation includes performing a scrolling operation, wherein a speed at which the scrolling operation is performed is based at least in part on the value.

7. The method of claim 6, wherein determining one or more inputs corresponds to detecting operation of a device that is operable to actuate one or more switches, wherein performing the operation includes (i) determining a directional input from the user actuating the device to actuate a switch corresponding to a particular direction, and (ii) determining the value corresponding to pressure applied by the user to determine the speed at which the scrolling operation is performed at a particular instance.

8. The method of claim 7, wherein determining the value corresponding to pressure applied by the user to determine the speed at which the scrolling operation is performed at the particular instance includes adjusting the speed in which the scrolling operation is performed based on a variation in the applied pressure from the user while the user is interacting with the input interface.

9. The method of claim 1, wherein determining one or more inputs includes determining one or more inputs from the user's interaction with the input interface selected from a group consisting of (i) a keypad, (ii) a button, (iii) a multi-way mechanism, and (iv) a contact sensitive display.

10. A computing device comprising:
a processor;
a multi-state interface component coupled to the processor, the interface component being operable to actuate an input to the processor for each of a plurality of states;
a pressure-sensitive mechanism positioned to detect pressure applied by the user when operating the multi-state interface component, the pressure-sensitive mechanism being coupled to provide an output for use by the processor, the output corresponding to a value of the pressure applied by the user;
wherein the processor is configured to:
detect whether the value of the pressure applied by the user when operating the multi-state interface component exceeds a designated threshold;
in response to detecting that the pressure applied by the user when operating the multi-state interface component exceeds the designated threshold, alter performance of one or more operations based on the combination of the value of the pressure and the input from the multi-state interface component;
in response to detecting that the pressure applied by the user when operating the multi-state interface component does not exceed the designated threshold, perform one or more operations based on the input from the multi-state interface component and not the value of the applied pressure.

11. The computing device of claim 10, wherein the pressure-sensitive mechanism is a force sensor that detects the applied pressure as an analog value.

12. The computing device of claim 10, wherein the multi-state interface component and the pressure-sensitive mechanism are positioned relative to one another so that the multi-state interface component overlays the pressure-sensitive mechanism.

13. The computing device of claim 10, wherein the multi-state interface component mechanism is operable to actuate any one of a plurality of directional states and at least one selection state.

14. The computing device of claim 13, wherein the multi-state interface component mechanism includes one or more buttons.

15. The computing device of claim 10, wherein the processor is configured to alter performance of the one or more operations based on the value of the pressure.

16. The computing device of claim 15, wherein the one or more operations correspond to a scrolling function, and wherein the processor is configured to alter performance of the one or more operations by altering a speed at which the scrolling function is performed based at least in part on the value of the applied pressure.

17. The computing device of claim 16, wherein the processor is configured to alter the speed at which the scrolling function is performed by increasing and/or decreasing the speed at which the scrolling function is performed based on the value of the of the applied pressure.

18. The computing device of claim 17, wherein the processor is configured to adjust the speed at which the scrolling function is performed based on changes to the applied pressure when the user is operating the multi-state interface component.

19. A method for processing input on a computing device, the method comprising:
detecting that pressure applied by a user when interacting with an input interface on the computing device exceeds a threshold;
in response to detecting that the pressure exceeds the threshold, performing an operation that is based on combining one or more inputs from the input interface and a value that corresponds to an amount of pressure applied by the user.

20. The method of claim 19, wherein detecting that pressure applied by the user exceeds the threshold includes detecting a value that corresponds to the amount of pressure applied by the user, and wherein performing the operation is based in part on the value of the applied pressure.

21. The method of claim 20, wherein performing the operation includes performing a scrolling operation, wherein a speed at which the scrolling operation is performed is based at least in part on the value.

22. The method of claim 19, further comprising detecting the user interacting with the multi-state interface device, including receiving digital input form the user interacting with the multi-state interface device.

23. The method of claim 22, wherein detecting that pressure applied by the user exceeds the threshold is performed using an analog sensor.

24. An interface assembly for a computing device, the interface comprising:
a multi-state input interface that is actuatable into a plurality of states, including into a central actuated state and any one of a plurality of directional states, central location and in any one of a plurality of directions, wherein the multi-state input interface is coupled to a processor of the computing device to provide the processor with a value corresponding to one of the plurality of states that is actuated at any given instance; and
a pressure-detection mechanism that detects a pressure applied by the user when the user interacts with the multi-state input interface, wherein the pressure-detection mechanism outputs a value for the processor that corresponds to an amount of pressure applied by the user at any given instance during which the user interacts with the multi-state input interface.

25. A method for enabling scrolling on a computing device, the method comprising:
processing a directional input provided by a user interacting with a multi-directional interface in connection with a scroll operation, the directional operation corresponding to a direction of the scroll operation;
determining a value of an applied pressure by the user interacting with the multi-directional interface; and
increasing at least one of a speed or acceleration of the scroll operation in the direction of the scroll operation, wherein increasing the speed or the acceleration is based on the value of the applied pressure.

26. A computing device comprising:
a processor;
a multi-state interface component coupled to the processor, the interface component being operable to actuate an input to the processor for each of a plurality of actuated states;
a pressure-sensitive mechanism positioned to detect pressure applied by the user when operating the multi-state interface component, the pressure-sensitive mechanism being coupled to provide an output for use by the processor, the output corresponding to a value of the pressure applied by the user;
wherein the processor is configured to:
detect whether one or more designated conditions are present when the user operates the multi-state interface component;
in response to detecting that the one or more designated conditions are present, alter performance of one or more operations based on the combination of the value of the pressure and the input from the multi-state interface component;
else, perform one or more operations based on the input from the multi-state interface component and not the value of the applied pressure.

27. The computing device of claim 26, wherein the one or more designated conditions include at least a first condition that corresponds to the user holding the multi-state interface component in one of the plurality of actuated states for a duration that exceeds a threshold in time.

28. The computing device of claim 27, wherein the one or more designated conditions correspond to at least a second condition that corresponds to the user applying pressure that exceeds a designated threshold while holding the multi-state interface component in the one of the plurality of actuated states.
